(19) United States
(12) Patent Application Publication
(10) Pub. No.: US 2024/0185593 A1
(43) Pub. Date: Jun. 6, 2024

(54) VEHICLE AND CONTROL METHOD THEREOF

(71) Applicants: Hyundai Motor Company, Seoul (KR); Kia Corporation, Seoul (KR)

(72) Inventors: Jonghyun Choi, Seoul (KR); Junsik An, Seoul (KR)

(21) Appl. No.: 18/384,591

(22) Filed: Oct. 27, 2023

(30) Foreign Application Priority Data
Dec. 1, 2022 (KR) 10-2022-0165948

(51) Int. Cl. G06V 10/98; B60W 60/00; G06V 10/77; G06V 10/774; G06V 10/776; G06V 10/82; G06V 20/58

(52) U.S. Cl. CPC G06V 10/98; B60W 60/001; G06V 10/7715; G06V 10/774; G06V 10/776; G06V 10/82; G06V 20/58; B60W 2420/403

(57) ABSTRACT

A vehicle may include: a sensor part including a plurality of cameras having fields of view different from each other; and a controller configured to process image data obtained by the sensor part, wherein the controller is configured to: train an image recognition model outputting a feature map by inputting training data stored in a learning database to the image recognition model, train a vulnerability assessment model outputting a vulnerability score by inputting a feature map output from the trained image recognition model to the vulnerability assessment model, extract a feature map by inputting the image data obtained by the sensor part to the trained image recognition model, determine a vulnerability score by inputting the extracted feature map to the trained vulnerability assessment model, determine whether logging is required based on the vulnerability score, and based on a determination that logging is required, store logging data in the learning database.

### CROSS-REFERENCE TO RELATED APPLICATION

This application is based on and claims priority to Korean Patent Application No. 10-2022-0165948, filed on Dec. 1, 2022 in the Korean Intellectual Property Office, the disclosure of which is incorporated herein by reference.

### TECHNICAL FIELD

The disclosure relates to a vehicle that may assess vulnerability of an image recognition model and a control method thereof.

### BACKGROUND

Requirements for autonomous vehicles may include capabilities to accurately identify and recognize various objects in an image based on a camera.

To satisfy the requirements, an algorithm capable of controlling a variety of conditions or variables may be required, and thus a deep learning algorithm may be applied to autonomous driving.

Training data for training a recognition network may be selected from real-time data of an autonomous vehicle, and the recognition network may be trained using the selected training data. For example, by inputting an accident event as a scene code, a frame likely to be an accident may be selected as a frame meaningful for training the recognition network.

However, because the above-described method lacks consideration of performance itself of recognition network of autonomous vehicle, and scene code classification is manually operated, selection of training data in real time and cultivation of recognition network may not be appropriately performed.

Descriptions in this background section are provided to enhance understanding of the background of the disclosure, and may include descriptions other than those of the prior art already known to those of ordinary skill in the art to which this technology belongs.

### SUMMARY

The following summary presents a simplified summary of certain features. The summary is not an extensive overview and is not intended to identify key or critical elements.

An aspect of the disclosure provides a vehicle that may automatically assess and remediate vulnerability of an image recognition model during driving and a control method thereof.

Additional aspects of the disclosure will be set forth in part in the description which follows and, in part, will be obvious from the description, or may be learned by practice of the disclosure.

A vehicle may comprise: a sensor part including a plurality of cameras having fields of view different from each other; and a controller configured to process image data obtained by the sensor part, wherein the controller is configured to: train an image recognition model by inputting training data to the image recognition model, wherein the image recognition model is configured to output a training feature map associated with the training data; train a vulnerability assessment model by inputting the training feature map to the vulnerability assessment model, wherein the vulnerability assessment model is configured to output a training vulnerability score associated with the training feature map; extract a feature map by inputting the image data obtained by the sensor part to the trained image recognition model; determine a vulnerability score by inputting the extracted feature map to the trained vulnerability assessment model; determine, based on the vulnerability score satisfying a threshold, to store logging data associated with the image data obtained by the sensor part; and transmit, to a storage device, the logging data.

While the vehicle is driving, the controller may be configured to: receive the image data obtained by the sensor part; extract the feature map by inputting the image data obtained by the sensor part to the trained image recognition model; and determine the vulnerability score by inputting the extracted feature map to the trained vulnerability assessment model.

The controller may be configured to train, based on at least one convolutional neural network (CNN), the image recognition model and the vulnerability assessment model.

The controller may be configured to determine the vulnerability score based on:

intersection over union (IOU); and an object image of which object recognition result for the extracted feature map is a false positive (FP), a false negative (FN), or a true positive (TP).

The vulnerability score may indicate an object recognition accuracy of at least one object associated with the image data obtained by the sensor part.

The controller may be configured to: derive a probability density function with the vulnerability score as an x-axis for each object recognition result which is a false positive (FP), a false negative (FN), or a true positive (TP) for the extracted feature map; and determine, based on the derived probability density function, the threshold as a logging threshold.

The controller may be configured to: determine, based on the derived probability density function, the threshold, wherein at least one of a false positive (FP) probability or a false negative (FN) probability is maximized at the threshold and wherein a true positive (TP) probability is minimized at the threshold; and set the threshold as a logging threshold.

The controller may comprise a model-learning part and a data logging part, wherein the model-learning part may be configured to train the image recognition model by inputting the training data that is stored in a learning database (DB) to the image recognition model, train the vulnerability assessment model by inputting the training feature map to the vulnerability assessment model, and transmit the trained image recognition model and the trained vulnerability assessment model to the data logging part, and wherein the data logging part may be configured to: receive and store the trained image recognition model and the trained vulnerability assessment model, while the vehicle is driving, extract the feature map by inputting the image data obtained by the sensor part to the trained image recognition model, determine the vulnerability score by inputting the extracted feature map to the trained vulnerability assessment model, determine whether logging is required based on the vulnerability score, and based on a determination that logging is required, transmit the logging data to the learning DB.

The model-learning part may be configured to train, based on a convolutional neural network (CNN), the image recognition model and the vulnerability assessment model.

The controller may be configured to: retrain, based on the logging data, the trained image recognition model; extract, based on the retrained image recognition model, a second feature map associated with second image data obtained by the sensor part; and control, based on the extracted second feature map, autonomous driving of the vehicle.

A control method of a vehicle may comprise: training an image recognition model by inputting training data to the image recognition model, wherein the image recognition model is configured to output a training feature map associated with the training data; training a vulnerability assessment model by inputting the training feature map to the vulnerability assessment model, wherein the vulnerability assessment model is configured to output a training vulnerability score associated with the training feature map; while the vehicle is driving, obtaining image data; extracting a feature map by inputting the image data to the trained image recognition model; determining a vulnerability score by inputting the extracted feature map to the trained vulnerability assessment model; determining, based on the vulnerability score satisfying a threshold, to store logging data associated with the image data; and transmitting, to a storage device, the logging data.

The training of the image recognition model may comprise training, based on a first convolutional neural network (CNN), the image recognition model, and wherein the training of the vulnerability assessment model comprises training, based on a second CNN, the vulnerability assessment model.

The determining of the vulnerability score may comprise determining the vulnerability score based on: intersection over union (IOU); and an object image of which object recognition result for the extracted feature map is a false positive (FP), a false negative (FN), or a true positive (TP).

The vulnerability score may indicate an object recognition accuracy of at least one object associated with the image data.

The method may comprise: deriving a probability density function with the vulnerability score as an x-axis for each object recognition result which is a false positive (FP), a false negative (FN), or a true positive (TP) for the extracted feature map; and determining, based on the derived probability density function, the threshold as a logging threshold.

The method may comprise: determining, based on the derived probability density function, the threshold, wherein at least one of a false positive (FP) probability or a false negative (FN) probability is maximized at the threshold and wherein a true positive (TP) probability is minimized at the threshold; and setting the threshold as a logging threshold.

The method may comprise: based on a quantity of pieces of logging data stored in a learning database (DB) cloud satisfying a quantity threshold, retraining the image recognition model and the vulnerability assessment model.

The method may comprise: retraining, based on the logging data, the trained image recognition model; extracting, based on the retrained image recognition model, a second feature map associated with second image data obtained by a sensor part; and controlling, based on the extracted second feature map, autonomous driving of the vehicle.

A non-transitory computer-readable medium may store computer-executable instructions for a processor to execute the method described herein.

These and other features and advantages are described in greater detail below.

### BRIEF DESCRIPTION OF THE DRAWINGS

These and/or other aspects of the disclosure will become apparent and more readily appreciated from the following description, taken in conjunction with the accompanying drawings of which:

FIG. 1 is a control block diagram of a vehicle;

FIG. 2 is a diagram illustrating a detailed configuration of a controller of a vehicle;

FIG. 3 is a flowchart illustrating operations of a control method of a vehicle;

FIG. 4 is a diagram illustrating operations of a model-learning part of a vehicle;

FIGS. 5 and 6 are graphs illustrating a probability density function of each case for each camera derived by a data logging part of a vehicle;

FIG. 7 is a diagram illustrating data logging operations of a data logging part in a controller of a vehicle;

FIG. 8 is a diagram illustrating operations of determining a vulnerability score using a segmentation model in a data logging part of a vehicle; and

FIG. 9 is a diagram illustrating data not logged and data logged in a vehicle.

### DETAILED DESCRIPTION

Like reference numerals throughout the specification denote like elements. Also, this specification does not describe all the elements according to the present disclosure, and descriptions well-known in the art to which the disclosure pertains or overlapped portions may be omitted. The terms such as “˜part”, “˜member”, “˜module”, “˜device”, and the like may refer to at least one process processed by at least one hardware or software. According to one or more aspects, a plurality of “˜parts”, “˜members”, “˜modules”, “˜devices” may be embodied as a single element, or a single of a “˜part”, “˜member”, “˜module”, “˜device” may include a plurality of elements.

It will be understood that when an element is referred to as being “connected” to another element, it can be directly or indirectly connected to the other element, wherein the indirect connection includes “connection” via a wireless communication network.

It will be understood that the term “include” when used in this specification, specifies the presence of stated features, integers, steps, operations, elements, and/or components, but does not preclude the presence or addition of at least one other features, integers, steps, operations, elements, components, and/or groups thereof.

It will be understood that when it is stated in this specification that a member is located “on” another member, not only a member may be in contact with another member, but also still another member may be present between the two members.

It will be understood that, although the terms first, second, etc. may be used herein to describe various elements, these elements should not be limited by these terms. It is to be understood that the singular forms are intended to include the plural forms as well, unless the context clearly dictates otherwise.

Reference numerals used for method steps are just used for convenience of explanation, but not to limit an order of the steps. Thus, unless the context clearly dictates otherwise, the written order may be practiced otherwise.

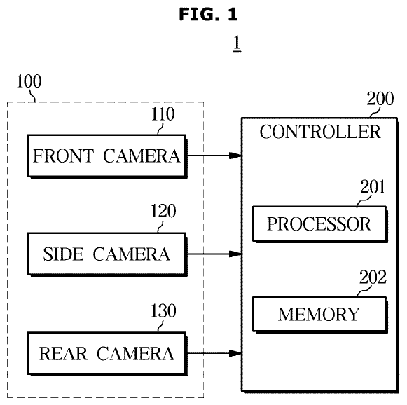

FIG. 1 is a control block diagram of a vehicle.

Referring to FIG. 1, a vehicle 1 may include a sensor part 100 obtaining image data around the vehicle 1 and including a front camera 110, a side camera 120, a rear camera 130, and the like, for assisting autonomous driving, and a controller 200 performing image processing based on an image signal obtained by the sensor part 100.

Although it is illustrated in FIG. 1 that the sensor part 100 only includes cameras, object recognition may be performed in a sensor fusion method using a radar and light detection and ranging (lidar) mounted in addition to the cameras. In at least some implementations, a radar, lidar, etc. may be mounted on the vehicle 1 (e.g., as part of the sensor part 100).

The front camera 110 may be installed on a front windshield and/or a front bumper of the vehicle 1 to secure a front field of view. In this instance, the front camera 110 may detect a moving object in front of the vehicle 1 and an obstacle, and the like, located in front left and right fields of view. The front camera 110 may transmit an image signal obtained in front field of view to the controller 200, such that the controller 200 processes front image data.

The side camera 120 may be symmetrically installed on B pillars, and the like, of the vehicle 1 to secure the left and right fields of view. The side camera 120 may be installed on the left and right sides of the vehicle 1 to detect a moving object travelling side by side in adjacent lanes and pedestrians approaching the vehicle 1. The side camera 120 may transmit an image signal obtained at left and right fields of view to the controller 200, such that the controller 200 processes side image data.

The rear camera 130 may be installed on a rear windshield and/or a rear bumper of the vehicle 1, to secure a rear field of view. In this instance, the rear camera 130 may detect a moving object at rear of the vehicle 1 and an obstacle, and the like, located in rear left and right fields of view. The rear camera 130 may transmit an image signal obtained in the rear field of view to the controller 200, such that the controller 200 processes rear image data.

Although it has been described above that total four cameras constitute the sensor part 100, a configuration of the sensor part 100 is not limited thereto. Also, for recognition performance improvement, the sensor part 100 may include more cameras such as 6 channels, 8 channels, 12 channels, and the like. Also, a position of each of the cameras may be changed to secure an optimal field of view according to a structure of the vehicle 1.

The sensor part 100 may include a plurality of lens and image sensors. The sensor part 100 may be implemented as a wide-angle camera, and secure omnidirectional views based on the vehicle 1.

The sensor part 100 may have camera internal parameters determined for each vehicle manufacturer. For example, the camera internal parameters may include a focal length, a principal point, and a skew coefficient. The sensor part 100 may have camera external parameters determined based on a physical location of a camera. For example, the camera external parameters may include camera installation height, camera installation direction (pan, tilt), and the like.

The controller 200 may obtain an actual distance between the vehicle 1 and an object through a distance value table where a ground reference distance value of each pixel is assigned using the camera internal parameter according to the sensor part 100.

The controller 200 may include an image signal processor and a micro control unit (MCU). Here, the image signal processor may include a processor 201 processing image data of the sensor part 100, and the MCU may generate an acceleration/deceleration signal output on a speed device of the vehicle, a braking signal output on a brake device, and/or a steering signal output on a steering device based on the image data processing result.

In an autonomous driving mode, when image data is received from the sensor part 100, the controller 200 may recognize lanes of a road through image processing, recognize a lane in which the vehicle 1 travels based on location information of the recognized lanes, determine whether both left and right lines of the lane in which the vehicle 1 travels are recognized, and if it is determined that both lines are all recognized, control autonomous driving based on the recognized lines.

During autonomous driving, the controller 200 may identify objects in an image based on the image data obtained by the sensor part 100, and determine whether the objects in the image are stationary obstacles or moving obstacles by a deep learning algorithm.

The controller 200 may obtain location information (direction) and type information (e.g., whether an obstacle is another vehicle, a pedestrian, a cyclist, a curb, a guardrail, a street tree, a streetlight, or the like) of an obstacle located in front of the vehicle 1 based on the image data of the sensor part 100.

The controller 200 may obtain an actual distance between the vehicle 1 and an object, for each direction, based on the image data of the sensor part 100.

A memory 202 may store a program for processing image data, and/or data and/or program for the processor 201 to generate an acceleration/deceleration signal, a braking signal, and/or a steering signal, and the like.

The memory 202 may (e.g., temporarily) store the image data received from the sensor part 100 and a processing result of the image data.

The memory 202 may be implemented with at least one of a volatile memory such as a random access memory (RAM), a non-volatile memory such as a cache, a flash memory, a read only memory (ROM), a programmable read only memory (PROM), an erasable programmable read only memory (EPROM), an electrically erasable programmable read only memory (EEPROM), etc., or a recording media such as a hard disk drive (HDD), or a compact disc read only memory (CD-ROM), without being limited thereto.

The memory 202 and the processor 201 may be integrated into one chip, or provided as separate chips.

The vehicle 1 may automatically select vulnerability of an image recognition model by using an assessment metric for assessing vulnerability of the image recognition model and a deep learning model capable of estimating the metric, thereby continuously improving a system performance. The vehicle 1 may propose an assessment metric for assessing vulnerability of the image recognition model, present a deep learning model capable of estimating the assessment metric, and automatically estimate and assess vulnerability of a deep learning network during driving by optimizing a threshold value of a corresponding assessment metric for each camera. Accordingly, data management may be easily performed and system performance may be continuously complemented.

Although not illustrated, the vehicle 1 may include a communication device (e.g., a wireless communication modem and/or a wired communication device). The vehicle 1 may communicate with an external device (e.g., a server, a network, a cloud database, etc.) to send various pieces of data, such as training data, logging data, vulnerability score, etc. described herein.

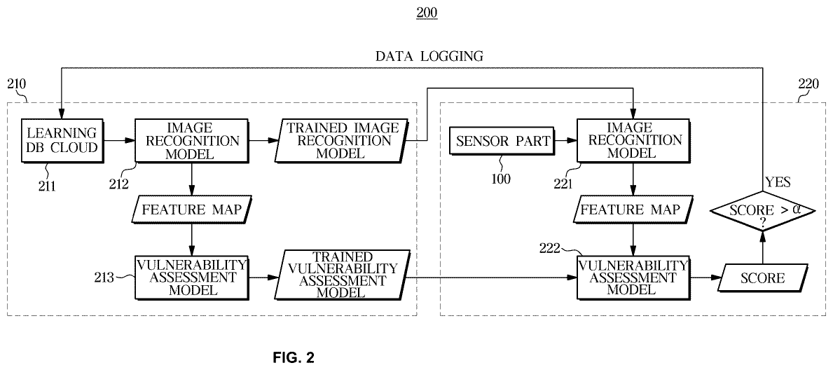

FIG. 2 is a diagram illustrating a detailed configuration of a controller of a vehicle.

Referring to FIG. 2, the controller 200 may include a model-learning part 210 and a data logging part 220.

The model-learning part 210 may include a learning database (DB) cloud 211, an image recognition model 212, and a vulnerability assessment model 213.

The learning DB cloud 211 may store training data for training the image recognition model 212.

The image recognition model 212 may include an image recognition program and/or an image recognition algorithm that recognizes an object in an image. The image recognition model 212 may include a variety of image recognition models from image classification to object detection and segmentation.

The image recognition model 212 may estimate a location of an object in a trained image using input training data.

The vulnerability assessment model 213 may include a vulnerability assessment program and/or vulnerability assessment algorithm that may assess vulnerability of the image recognition model 212.

The model-learning part 210 may train the image recognition model 212 using the training data of the learning database (DB) cloud 211. Training the image recognition model 212 may include a process of finding and/or learning a model parameter optimized for training data.

The model-learning part 210 may perform preprocessing of extracting a feature map of the input image by inputting training data to the image recognition model 212. The model-learning part 210 may output the extracted feature map after preprocessing.

The model-learning part 210 may train the vulnerability assessment model 213 by inputting the feature map output from the image recognition model 212 to the vulnerability assessment model 213. Training the vulnerability assessment model 213 may include a process of finding and/or learning a model parameter optimized for feature map.

The model-learning part 210 may transmit the trained image recognition model and the trained vulnerability assessment model to the data logging part 220.

As such, the model-learning part 210 may train the image recognition model 212 through the training data of the learning DB cloud 211, train the vulnerability assessment model 213 after preprocessing of extracting the feature map by inputting the training data to the image recognition model 212 again, and transmit the trained image recognition model and the trained vulnerability assessment model to the data logging part 220.

The data logging part 220 may receive and store an image recognition model 221, which may be the trained image recognition model, and a vulnerability assessment model 222, which may be the trained vulnerability assessment model provided by the model-learning part 210.

The data logging part 220 may calculate a logging threshold for each camera of the sensor part 100, using verification data obtained from the training data and a probability density function for each recognition type.

If the vehicle 1 starts driving, the data logging part 220 may input the image data input by the sensor part 100 to the image recognition model 221, thereby allowing the image recognition model 221 to perform an inference process.

After performing the inference process on the image data through the image recognition model 221, the data logging part 220 may input a feature map (e.g., which may be a result of inference) to the vulnerability assessment model 222 again to calculate a score of each image.

The data logging part 220 may determine whether logging is required based on the score and a logging rule. If it is determined that logging is required, the data logging part 220 may transmit data that requires logging to the learning DB cloud 211 of the model-learning part 210.

The above-described operations of the model-learning part 210 and the data logging part 220 may be performed in cycles to continuously improve a performance of the image recognition model 221.

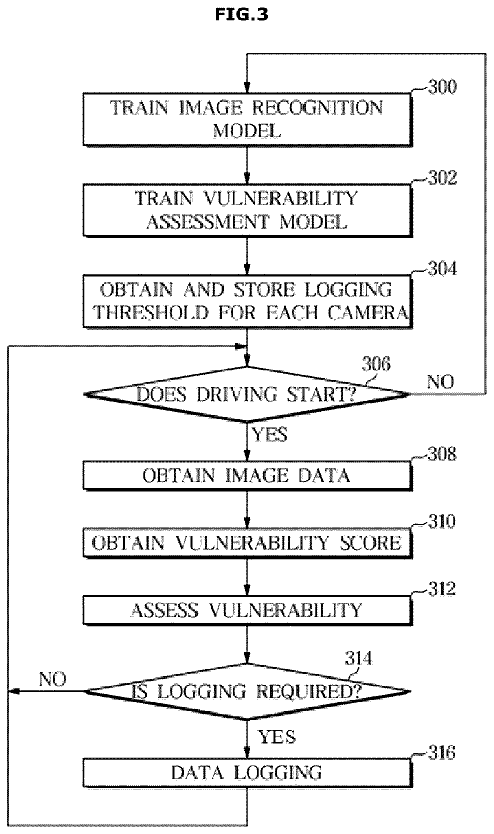

FIG. 3 is a flowchart illustrating operations of a control method of a vehicle.

Referring to FIG. 3, the vehicle 1 may train the image recognition model 212 using training data (300).

The controller 200 may train the image recognition model 212 by inputting the training data stored in the learning DB cloud 211 to the image recognition model 212. The image recognition model 212 may estimate a location of an object in a trained image by using the input training data.

The vehicle 1 may train the vulnerability assessment model 213 for assessing vulnerability of the image recognition model 212 (302).

The vehicle 1 may train the vulnerability assessment model 213 using the image recognition model 212 and training data.

The controller 200 may train the vulnerability assessment model 213 based on a feature map output from the image recognition model 212.

The vehicle 1 may obtain and store a logging threshold for each camera of the trained vulnerability assessment model (304).

The controller 200 may calculate the logging threshold for each camera of the sensor part 100 using verification data obtained from the training data and a probability density function for each recognition type.

The vehicle 1 may determine whether the driving of the vehicle 1 starts (306).

If the vehicle 1 starts driving (Yes in operation 306), the vehicle 1 may obtain image data through the sensor part 100 (308).

The vehicle 1 may obtain a vulnerability score for image data through the trained vulnerability assessment model (310).

The vehicle 1 may assess vulnerability of the trained image recognition model based on the vulnerability score (312).

The vehicle 1 may determine whether data logging is required depending on a result of vulnerability assessment (314).

If it is determined that data logging is required (Yes in operation 314), the vehicle 1 may log corresponding data to the learning DB cloud (316). Afterwards, the vehicle 1 may perform the operation 306 and following operations.

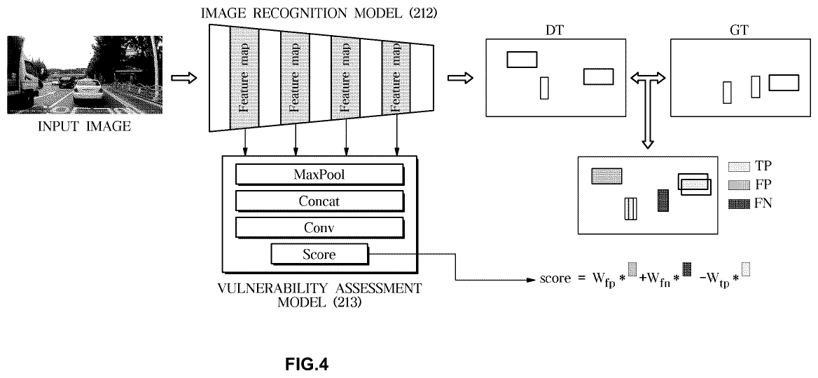

FIG. 4 is a diagram illustrating operations of a model-learning part of a vehicle.

Referring to FIG. 4, the model-learning part 210 may train the image recognition model 212 using training data stored in the learning DB cloud 211. In this instance, the image recognition model 212 may be trained in a same manner as an existing image recognition model training method using deep learning.

The model-learning part 210 may train the vulnerability assessment model using the trained image recognition model. The image recognition model 212 may output a feature map of an input image. The model-learning part 210 may determine a vulnerability score based on the feature map output from the image recognition model 212, and train the vulnerability assessment model 213 by optimizing a model parameter of the vulnerability assessment model 213 based on the vulnerability score.

For example, directly determining vulnerability from the input image may be inappropriate due to lack of consideration for an actual image recognition model.

According to one or more implementations, in order to accurately reflect an actual vulnerability of the image recognition model 212, an input image may not be directly input to the vulnerability assessment model 213. For example, the input image may be sent to the image recognition model 212 and preprocessed by converting the input image into a feature map output from an encoder of the image recognition model 212. Through the preprocessing process, the input image may be preprocessed in a manner that reflects an actual performance of the image recognition model 212.

The image recognition model 212 may receive image data, and output information (e.g., about a location, a type, and the like) of an object in the input image, for example, as a two-dimensional (2D) bounding box.

The image recognition model 212 may be trained by a deep learning algorithm. The deep learning algorithm may be a method for training the image recognition model. The object may include, for example, a pedestrian and/or another vehicle and/or a cyclist, and the like, without being limited thereto.

The deep learning algorithm may be one of machine learning algorithms, and refer to a modeling technique developed, for example, from an artificial neural network (ANN) modeled after a human neural network. The ANN may be composed of a multi-layered structure.

The ANN may have a layer structure including an input layer, an output layer, and at least one intermediate layer (or hidden layer, e.g., Kernel) between the input layer and the output layer. Based on the above multi-layered structure, the deep learning algorithm may derive highly reliable results through a learning process to optimize weights of activation functions between layers.

For example, the deep learning algorithm may include a convolutional neural network (CNN), without being limited thereto. According to one or more aspects of the disclosure, it should be understood that another deep learning algorithm may be applied.

Unlike an existing technique in which learning is performed by extracting knowledge from existing data, the CNN applied in the present disclosure may have a structure of extracting features of data and recognizing patterns of the features. The CNN may be performed through a convolution process and a pooling process. In other words, the CNN may include an algorithm where a convolution layer and a pooling layer are complexly structured. Here, a data feature extraction (e.g., a convolution process) is performed in the convolution layer. The convolution process includes a process of examining adjacent components of each component to identify features in data and derive the identified features into one feature map. The convolution process may effectively reduce the number of parameters, as a compression process. In the pooling layer, a process (e.g., a pooling process) of reducing the size of layers passing through the convolution layer may be performed. The pooling process may reduce the size of data, cancel noise, and provide consistent features in tiny parts. For example, the CNN may be used in various fields such as an information extraction, a sentence classification, and a face recognition. Because CNN is a known technology, a detailed description of other features thereof is omitted herein.

The image recognition model 212 may have a general layer structure and output feature maps of different sizes for each layer.

The vulnerability assessment model 213 may change the feature maps of different sizes, output from the image recognition model 212, to a same size feature map through MaxPooling layers of different sizes.

The vulnerability assessment model 213 may output a vulnerability score by forward-passing the size-adjusted feature map to a concatenation layer and the convolution layer. The concatenation layer may be a process of concatenating two feature maps corresponding to each other in a channel dimension.

Because a training image is a database having a clear ground truth (GT), the vulnerability assessment model 213 may determine the vulnerability score by measuring how different an actual GT and a deep learning output (DT) are. The GT may refer to data including a location and/or type of an object in an image.

In an example, from each of GT object, DT object, and object confidence score in all images, a score of a specific image may be calculated by Equation 1 below.

$$score = {W}_{fp} {\sum }_{i = 1}^{{n}_{fp}} {w}_{i} * {h}_{i} + {W}_{fn} {\sum }_{j = 1}^{{n}_{fn}} ( 1 - {IOU}_{j}^{fn} ) * {w}_{j} * {h}_{j} - {W}_{fp} {\sum }_{i = k}^{{n}_{fp}} {IOU}_{k}^{fp} * {w}_{k} * {h}_{k} \qquad [ Equation 1 ]$$

where W_{fp}, W_{fn}, and Wₜₚ denote weights of a false positive, a false negative, and a true positive, respectively, IOUᵢ denotes an object intersection over union (IOU) of an i^{th} object, and Wₖ and hₖ denote a width and a height of object bounding box of a k^{th} object, respectively.

The bounding box is a result of predicting a location of an object in an image, in a rectangular form using an x-axis and a y-axis.

A confidence score is a probability of predicting a range of an object existing in a specific bounding box.

The IOU is an index for evaluating an accuracy of object detection (e.g., an index indicating how much two bounding boxes match).

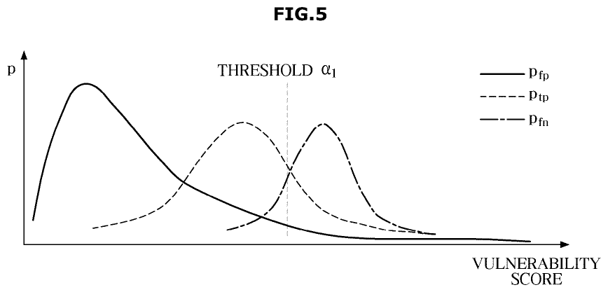

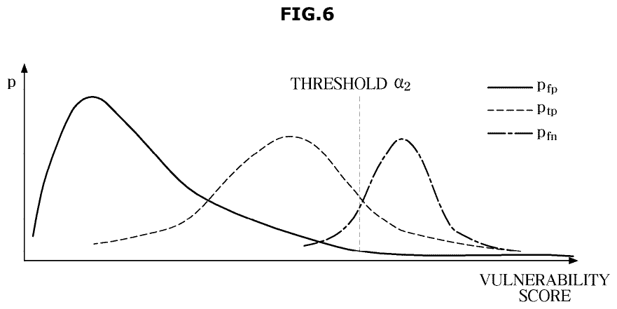

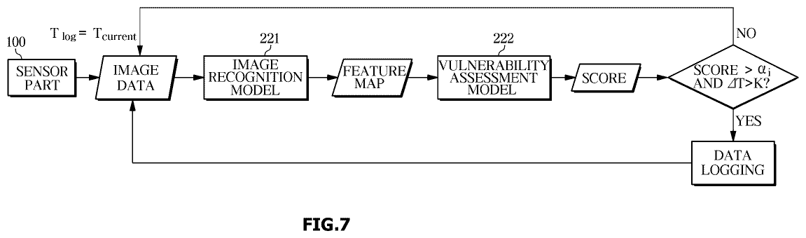

FIGS. 5 and 6 are graphs of a probability density function of each case for each camera derived by a data logging part of a vehicle. FIG. 7 is a diagram illustrating example data logging operations of a data logging part in a controller of a vehicle.

Referring to FIGS. 5 to 7, the data logging part 220 may receive and store weights (e.g., deep learning weights) of an image recognition model and vulnerability assessment model trained by the model-learning part 210.

The data logging part 220 may calculate and store a logging threshold for each camera of the vulnerability assessment model 212 using verification data of the model-learning part 210.

The data logging part 220 may calculate and store the logging threshold for each camera of the sensor part 200 through verification data obtained from training data and a probability density function for each recognition type.

The probability density function for each recognition type may include probability density functions such as a false positive (FP), a false negative (FN), and a true positive (TP).

The data logging part 220 may classify each verification DB into three cases of false positive (FP), false negative (FN), and true positive (TP).

With respect to each of the three cases, the data logging part 220 may generate a histogram having a vulnerability score as an x-axis for each camera of the sensor part 100, and divide by the total number, thereby deriving the respective probability density function. The probability density function is a function representing a distribution of vulnerability scores which are probability variables, and an area thereof is a probability.

Pfp is a probability density function in case of false positive (FP).

Pnp is a probability density function in case of false negative (FN).

Ptp is a probability density function in case of true positive (TP).

A probability mass function may be a function representing a distribution of vulnerability scores which are probability variables, and a function value is a probability.

Through a sum of the probability density function and the probability mass function, an optimal threshold value maximizing a probability of false positive (FP) and/or a probability of false negative (FN) and minimizing a probability of true positive (TP) may be calculated. Accordingly, a threshold value capable of maximizing only a vulnerable DB may be determined as a logging threshold for each camera.

In an example, the optimal threshold value may be calculated by [Equation 2] below.

$${α}_{i} = arg {max}_{score} {\int }_{score}^{∞} {p}_{fp}^{i} - {\int }_{score}^{∞} {p}_{tp}^{i} + {\int }_{score}^{∞} {p}_{fn}^{i} \qquad [ Equation 2 ]$$

where Pfp denotes a probability density function in case of false positive (FP), Pnp is a probability density function in case of false negative (FN), and Ptp is a probability density function in case of true positive (TP).

The data logging part 220 may automatically perform data logging through a logging threshold and deep learning weights.

If the vehicle starts driving, the data logging part 220 may input image data input from the sensor part 100 to the image recognition model 221, input a feature map output from the image recognition model 221 to the vulnerability assessment model 222, and determine whether logging is required based on logging rules and an image score output from the vulnerability assessment model 222. For example, if a time difference (ΔT=T_{log}−T_{current}) among currently stored scenes for each camera exceeds a preset time (K seconds) and a corresponding image score exceeds the logging threshold, it may be determined that logging is required.

If logging is required, the data logging part 220 may transmit and store data that requires logging to the learning DB cloud 211 of the model-learning part 210.

The data logging part 220 may continuously repeat the logging operation described above during driving.

If logging data is accumulated in the learning DB cloud 211 by a preset number of target quantities, the vehicle 1 may train the image recognition model 221 using the logging data again, and thus vulnerability of image recognition model may be complemented and a performance of the image recognition model may be continuously improved.

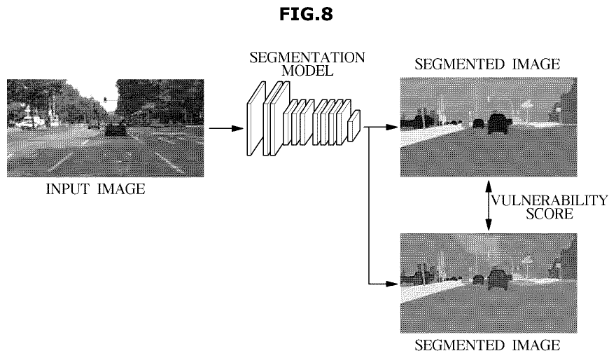

FIG. 8 is a diagram illustrating example operations of determining a vulnerability score using a segmentation model in a data logging part of a vehicle.

Referring to FIG. 8, shown is a segmentation result (e.g., a result of classifying an input image into a vehicle, roads, background, and the like) through a segmentation model.

In some implementations, an image recognition model may receive image data as input, and output information (e.g., about locations, types, and the like) of objects in an image as a 2D bounding box. A target model of the disclosure may be a 2D bounding box detection model.

However, a vulnerability score proposed by the disclosure may be applicable to a segmentation model. For example, a location and a type of an object may be recognized as semantic segmentation, instead of a 2D bounding box. The semantic segmentation refers to classification of object in an image in pixel units.

By confirming whether a specific pixel is correctly recognized and reflecting a result of confirmation in IOU calculation, a vulnerability score may be calculated the same. Through the above, the vulnerability assessment model may be trained.

The disclosure relates to assessing vulnerability of a specific image recognition model and performing logging, not to use of image recognition model.

According to the disclosure, a vulnerability score may be for assessing vulnerability by calculating an accurately recognized area and an incorrectly recognized area in an image. An equation for calculating the vulnerability score is replaceable. For example, in terms of three-dimensional (3D) image recognition, an error in depth may be used to determine a difference between an actual depth and an estimated depth as a vulnerability assessment indicator. The disclosure relates to calculation of vulnerability score for each image and estimation of vulnerability score through an artificial intelligence (AI) model, not to calculation formula itself of the vulnerability score.

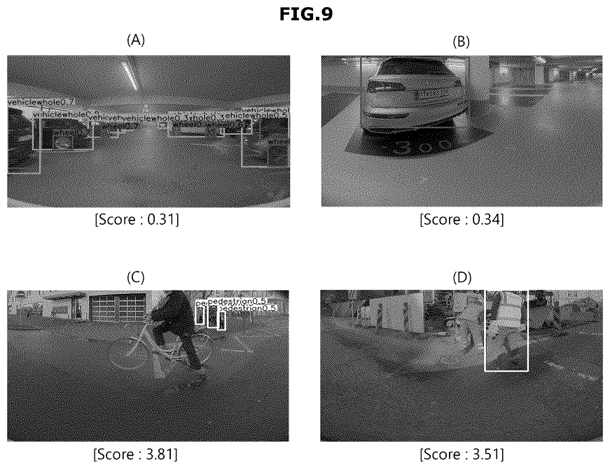

FIG. 9 is a diagram illustrating data not logged and data logged in a vehicle.

In FIG. 9, part (A) and part (B) illustrate image data where an image recognition model succeeds in object recognition, and part (C) and part (D) illustrate image data where the image recognition model fails object recognition.

Vulnerability scores of part (A) and part (B) are 0.31 and 0.34, respectively, which are smaller than a logging threshold (e.g., 2). Accordingly, it may be confirmed that logging is not performed.

However, vulnerability scores of part (C) and part (D) are 3.81 and 3.51, respectively, which are greater than the logging threshold. Accordingly, it may be confirmed that logging is performed. In this instance, it may be seen that part (C) and part (D) are automatically selected and reflected in next training, thereby training vulnerability of the image recognition model.

A vehicle may include: a sensor part including a plurality of cameras having fields of view different from each other; and a controller configured to process image data obtained by the sensor part. The controller may be configured to: train an image recognition model outputting a feature map by inputting training data stored in a learning database (DB) cloud to the image recognition model, train a vulnerability assessment model outputting a vulnerability score by inputting a feature map output from the trained image recognition model to the vulnerability assessment model, extract a feature map by inputting the image data obtained by the sensor part to the trained image recognition model, determine a vulnerability score by inputting the extracted feature map to the trained vulnerability assessment model, determine whether logging is required based on the vulnerability score, and based on a determination that logging is required, store logging data in the learning DB cloud.

In response to the vehicle starting driving, the controller may be configured to extract the feature map by inputting the image data obtained by the sensor part to the trained image recognition model, and determine the vulnerability score by inputting the extracted feature map to the trained vulnerability assessment model.

The controller may be configured to train the image recognition model and the vulnerability assessment model based on a convolutional neural network (CNN).

The controller may be configured to determine the vulnerability score based on intersection over union (IOU) and an object image whose object recognition result for the extracted feature map may be a false positive (FP), a false negative (FN), or a true positive (TP).

The controller may be configured to determine that logging may be required, based on the vulnerability score being greater than a logging threshold.

The controller may be configured to derive a probability density function with the vulnerability score as an x-axis for each object recognition result which is a false positive (FP), a false negative (FN), or a true positive (TP) for the extracted feature map, and determine the logging threshold based on the derived probability density function.

The controller may be configured to determine a threshold maximizing at least one of a false positive (FP) probability and a false negative (FN) probability and minimizing a true positive (TP) probability from the derived probability density function, and determine the determined threshold as the logging threshold.

The controller may include a model-learning part and a data logging part. The model-learning part may be configured to train the image recognition model by inputting the training data stored in the learning DB cloud to the image recognition model, train the vulnerability assessment model by inputting the feature map output from the trained image recognition model to the vulnerability assessment model, and transmit the trained image recognition model and the trained vulnerability assessment model to the data logging part. The data logging part may be configured to: receive and store the trained image recognition model and the trained vulnerability assessment model, in response to the vehicle starting driving, extract the feature map by inputting the image data obtained by the sensor part to the trained image recognition model, determine the vulnerability score by inputting the extracted feature map to the trained vulnerability assessment model, determine whether logging is required based on the vulnerability score, and based on a determination that logging is required, transmit the logging data to the learning DB cloud.

The model-learning part may be configured to train the image recognition model and the vulnerability assessment model based on a convolutional neural network (CNN).

The data logging part may be configured to determine the vulnerability score based on intersection over union (IOU) and an object image whose object recognition result for the extracted feature map is a false positive (FP), a false negative (FN), or a true positive (TP), and determine that logging is required, based on the vulnerability score being greater than a logging threshold.

The data logging part may be configured to derive a probability density function with the vulnerability score as an x-axis for each object recognition result which is a false positive (FP), a false negative (FN), or a true positive (TP) for the extracted feature map, and determine the logging threshold based on the derived probability density function.

The data logging part may be configured to determine a threshold maximizing at least one of a false positive (FP) probability and a false negative (FN) probability and minimizing a true positive (TP) probability from the derived probability density function, and determine the determined threshold as the logging threshold.

A control method of a vehicle may include: training an image recognition model outputting a feature map by inputting training data stored in a learning DB cloud to the image recognition model; training a vulnerability assessment model outputting a vulnerability score by inputting a feature map output from the trained image recognition model to the vulnerability assessment model; obtaining image data, in response to the vehicle starting driving; extracting a feature map by inputting the image data to the trained image recognition model; determining a vulnerability score by inputting the extracted feature map to the trained vulnerability assessment model; determining whether logging is required based on the vulnerability score; and storing logging data in the learning DB cloud, based on a determination that logging is required.

The training of the image recognition model and the vulnerability assessment model may include training the image recognition model and the vulnerability assessment model based on a convolutional neural network (CNN).

The determining of the vulnerability score may include determining the vulnerability score based on intersection over union (IOU) and an object image whose object recognition result for the extracted feature map is a false positive (FP), a false negative (FN), or a true positive (TP).

The determining of whether logging is required may include determining that logging is required, based on the vulnerability score being greater than a logging threshold.

The determining of whether logging is required may include deriving a probability density function with the vulnerability score as an x-axis for each object recognition result which is a false positive (FP), a false negative (FN), or a true positive (TP) for the extracted feature map, and determining the logging threshold based on the derived probability density function, and determining that logging is required, based on the vulnerability score being greater than the determined logging threshold.

The determining of the logging threshold may include determining a threshold maximizing at least one of a false positive (FP) probability and a false negative (FN) probability and minimizing a true positive (TP) probability from the derived probability density function, and determining the determined threshold as the logging threshold.

The control method may further include: based on a number of pieces of logging data stored in the learning DB cloud being preset number, retraining the image recognition model and the vulnerability assessment model using the logging data.

A non-transitory computer-readable medium storing computer-executable instructions for a processor to execute the method described above.

As described above, according to the disclosure, vulnerability of the image recognition model may be automatically assessed and complemented during driving, thereby continuously remediating vulnerability of a deep learning model and improve a system performance, and eliminating time and/or economic loss due to data selection.

As is apparent from the above, according to the disclosure, a vehicle can automatically assess and remediate vulnerability of an image recognition model during driving, thereby continuously making up for a weakness of a deep learning model, improving a system performance, and eliminating time and/or economic loss due to data selection.

Meanwhile, the aforementioned controller and/or its constituent components may include at least one processor/microprocessor(s) combined with a computer-readable recording medium storing a computer-readable code/algorithm/software. The processor/microprocessor(s) may execute the computer-readable code/algorithm/software stored in the computer-readable recording medium to perform the above-descried functions, operations, steps, and the like.

The aforementioned controller and/or its constituent components may further include a memory implemented as a non-transitory computer-readable recording medium or transitory computer-readable recording medium. The memory may be controlled by the aforementioned controller and/or its constituent components and configured to store data, transmitted to or received from the aforementioned controller and/or its constituent components, or data processed or to be processed by the aforementioned controller and/or its constituent components.

The disclosed features may be implemented as the computer-readable code/algorithm/software in the computer-readable recording medium. The computer-readable recording medium may be a non-transitory computer-readable recording medium such as a data storage device capable of storing data readable by the processor/microprocessor(s). For example, the computer-readable recording medium may be a hard disk drive (HDD), a solid state drive (SSD), a silicon disk drive (SDD), a read only memory (ROM), a compact disc read only memory (CD-ROM), a magnetic tape, a floppy disk, an optical recording medium, and the like.

What is claimed is:

1. A vehicle comprising:
a sensor part including a plurality of cameras having fields of view different from each other; and
a controller configured to process image data obtained by the sensor part,
wherein the controller is configured to:
train an image recognition model by inputting training data to the image recognition model, wherein the image recognition model is configured to output a training feature map associated with the training data;
train a vulnerability assessment model by inputting the training feature map to the vulnerability assessment model, wherein the vulnerability assessment model is configured to output a training vulnerability score associated with the training feature map;
extract a feature map by inputting the image data obtained by the sensor part to the trained image recognition model;
determine a vulnerability score by inputting the extracted feature map to the trained vulnerability assessment model;
determine, based on the vulnerability score satisfying a threshold, to store logging data associated with the image data obtained by the sensor part; and
transmit, to a storage device, the logging data.

2. The vehicle of claim 1, wherein, while the vehicle is driving, the controller is configured to:
receive the image data obtained by the sensor part;
extract the feature map by inputting the image data obtained by the sensor part to the trained image recognition model; and
determine the vulnerability score by inputting the extracted feature map to the trained vulnerability assessment model.

3. The vehicle of claim 1, wherein the controller is configured to train, based on at least one convolutional neural network (CNN), the image recognition model and the vulnerability assessment model.

4. The vehicle of claim 1, wherein the controller is configured to determine the vulnerability score based on:
intersection over union (IOU); and
an object image of which object recognition result for the extracted feature map is a false positive (FP), a false negative (FN), or a true positive (TP).

5. The vehicle of claim 1, wherein the vulnerability score indicates an object recognition accuracy of at least one object associated with the image data obtained by the sensor part.

6. The vehicle of claim 1, wherein the controller is configured to:
derive a probability density function with the vulnerability score as an x-axis for each object recognition result which is a false positive (FP), a false negative (FN), or a true positive (TP) for the extracted feature map; and
determine, based on the derived probability density function, the threshold as a logging threshold.

7. The vehicle of claim 6, wherein the controller is configured to:
determine, based on the derived probability density function, the threshold, wherein at least one of a false positive (FP) probability or a false negative (FN) probability is maximized at the threshold and wherein a true positive (TP) probability is minimized at the threshold; and
set the threshold as a logging threshold.

8. The vehicle of claim 1, wherein the controller comprises a model-learning part and a data logging part,
wherein the model-learning part is configured to train the image recognition model by inputting the training data that is stored in a learning database (DB) to the image recognition model, train the vulnerability assessment model by inputting the training feature map to the vulnerability assessment model, and transmit the trained image recognition model and the trained vulnerability assessment model to the data logging part, and
wherein the data logging part is configured to:
receive and store the trained image recognition model and the trained vulnerability assessment model,
while the vehicle is driving, extract the feature map by inputting the image data obtained by the sensor part to the trained image recognition model,
determine the vulnerability score by inputting the extracted feature map to the trained vulnerability assessment model,
determine whether logging is required based on the vulnerability score, and
based on a determination that logging is required, transmit the logging data to the learning DB.

9. The vehicle of claim 8, wherein the model-learning part is configured to train, based on a convolutional neural network (CNN), the image recognition model and the vulnerability assessment model.

10. The vehicle of claim 1, wherein the controller is configured to:
retrain, based on the logging data, the trained image recognition model;
extract, based on the retrained image recognition model, a second feature map associated with second image data obtained by the sensor part; and
control, based on the extracted second feature map, autonomous driving of the vehicle.

11. A control method of a vehicle, the control method comprising:
training an image recognition model by inputting training data to the image recognition model, wherein the image recognition model is configured to output a training feature map associated with the training data;
training a vulnerability assessment model by inputting the training feature map to the vulnerability assessment model, wherein the vulnerability assessment model is configured to output a training vulnerability score associated with the training feature map;
while the vehicle is driving, obtaining image data;
extracting a feature map by inputting the image data to the trained image recognition model;
determining a vulnerability score by inputting the extracted feature map to the trained vulnerability assessment model;
determining, based on the vulnerability score satisfying a threshold, to store logging data associated with the image data; and
transmitting, to a storage device, the logging data.

12. The control method of claim 11, wherein the training of the image recognition model comprises training, based on a first convolutional neural network (CNN), the image recognition model, and
wherein the training of the vulnerability assessment model comprises training, based on a second CNN, the vulnerability assessment model.

13. The control method of claim 11, wherein the determining of the vulnerability score comprises determining the vulnerability score based on:
intersection over union (IOU); and
an object image of which object recognition result for the extracted feature map is a false positive (FP), a false negative (FN), or a true positive (TP).

14. The control method of claim 13, wherein the vulnerability score indicates an object recognition accuracy of at least one object associated with the image data.

15. The control method of claim 11, further comprising:
deriving a probability density function with the vulnerability score as an x-axis for each object recognition result which is a false positive (FP), a false negative (FN), or a true positive (TP) for the extracted feature map; and
determining, based on the derived probability density function, the threshold as a logging threshold.

16. The control method of claim 11, further comprising:
determining, based on the derived probability density function, the threshold, wherein at least one of a false positive (FP) probability or a false negative (FN) probability is maximized at the threshold and wherein a true positive (TP) probability is minimized at the threshold; and
setting the threshold as a logging threshold.

17. The control method of claim 11, further comprising:
based on a quantity of pieces of logging data stored in a learning database (DB) cloud satisfying a quantity threshold, retraining the image recognition model and the vulnerability assessment model.

18. The control method of claim 11, further comprising:
retraining, based on the logging data, the trained image recognition model;
extracting, based on the retrained image recognition model, a second feature map associated with second image data obtained by a sensor part; and
controlling, based on the extracted second feature map, autonomous driving of the vehicle.

19. A non-transitory computer-readable medium storing computer-executable instructions for a processor to execute the method according to claim 11.
